(19) United States
(12) Patent Application Publication
(10) Pub. No.: US 2023/0291340 A1
(43) Pub. Date: Sep. 14, 2023

(54) MOTOR CONTROL DEVICE

(71) Applicants: NATIONAL UNIVERSITY CORPORATION GUNMA UNIVERSITY, Maebashi-shi, Gunma (JP); SANDEN CORPORATION, Isesaki-shi, Gunma (JP)

(72) Inventors: Seiji HASHIMOTO, Maebashi-shi, Gunma (JP); Masayuki KIGURE, Isesaki-shi, Gunma (JP); Makoto SHIBUYA, Isesaki-shi, Gunma (JP)

(73) Assignees: NATIONAL UNIVERSITY CORPORATION GUNMA UNIVERSITY, Maebashi-shi, Gunma (JP); SANDEN CORPORATION, Isesaki-shi, Gunma (JP)

(21) Appl. No.: 18/040,278

(22) PCT Filed: Aug. 2, 2021
(86) PCT No.: PCT/JP2021/028558

§ 371 Date: Feb. 2, 2023

(30) Foreign Application Priority Data
Sep. 3, 2020 (JP) 2020-148516

(51) Int. Cl. H02P 21/00; H02P 21/13; H02P 21/18; H02P 21/22; G06N 3/084

(52) U.S. Cl. CPC H02P 21/0014; G06N 3/084; H02P 21/13; H02P 21/18; H02P 21/22; H02P 2207/05

(57) ABSTRACT

Provided is a motor control device capable of improving efficiency in real time by a neural network structure that directly derives, in a learning manner, an output signal providing optimal efficiency. A motor control device 1 is adapted to control a motor 6, and includes a neural network compensator 11 that receives input signals and repeats learning based on forward propagation and backpropagation thereby to derive an output signal providing optimal efficiency. Input signals are a motor current, a motor parameter and torque, and the like, and output signals are a current command value and a current phase command value. The motor 6 is controlled on the basis of an output signal derived by the neural network compensator 11.

### TECHNICAL FIELD

The present invention relates to a motor control device for controlling the operation of a motor.

### BACKGROUND ART

An interior permanent magnet (IPM) motor (permanent-magnet synchronous motor) has a structure in which a permanent magnet is placed inside a rotor, can be used in combination with reluctance torque, and allows higher efficiency to be easily achieved, and has therefore been extensively used in applications such as home appliances, industrial equipment, and automotive fields. Further, with the development of AI technology in recent years, the introduction of IPM motors has been considered also in the field of motor control.

For example, Patent Document 1 proposes a learning device and a learning method for optimizing the PI gain of a current controller in a motor current control system by learning with the overshoot amount, the undershoot amount, and the rise time of current as rewards with respect to a step-like torque command. In addition, Patent Document 2, for example, proposes a machine learning method whereby an optimal current command of a motor can be learned.

In this document, a current command value of a motor is derived by learning in which motor torque, a motor current, and a motor voltage are used as rewards. Further, Patent Document 3, for example, proposes a device that uses a neural network means to derive a primary voltage and a phase angle so as to control an induction machine.

### CITATION LIST

### Patent Documents

Patent Document 1: Japanese Unexamined Patent Application Publication No. 2017-34844
Patent Document 2: Japanese Unexamined Patent Application Publication No. 2018-14838
Patent Document 3: Japanese Patent No. 3054521

### SUMMARY OF THE INVENTION

### Problems to Be Solved by the Invention

However, there has been a problem that, even with the configuration described in any of the documents, it is still difficult to minimize losses and prevent the deterioration in efficiency with high responsiveness to fluctuations in motor parameters attributable to product variations and aging of motors.

The present invention has been made to solve the above-described technical problem with prior arts, and an object of the invention is to provide a motor control device capable of improving efficiency in real time by directly deriving an output signal providing optimal efficiency in a learning manner using a neural network structure.

### Means for Solving the Problems

A motor control device according to the present invention is a control device controlling a motor, and is characterized by including: a neural network compensator receiving an input signal and repeating learning based on forward propagation and backpropagation thereby to derive an output signal providing optimal efficiency, wherein the input signal is any one of, a combination of, or all of a motor current, a motor parameter, and torque, the output signal is a current command value and/or a current phase command value, and the motor is controlled on the basis of the output signal derived by the neural network compensator.

The motor control device according to the invention of claim 2 is characterized in the above-described invention in that the input signal is any one of, a combination of, or all of a q-axis current command value i_{q}*, a q-axis current i_{q}, a current peak command value iₚ*, a current peak value iₚ, a d-axis inductance L_{d}, a q-axis inductance L_{q}, a magnetic flux density φ, a torque command value τ*, and present torque _{T}.

The motor control device according to the invention of claim 3 is characterized in each of the above-described inventions in that the output signal is the current peak command value iₚ* and/or a current phase command value θ₁*.

The motor control device according to the invention of claim 4 is characterized in each of the above-described inventions in that the neural network compensator uses a squared torque error or a squared current error as a teacher signal, and derives an output signal from an input signal in a learning manner such that the teacher signal is minimized.

The motor control device according to the invention of claim 5 is characterized in each of the above-described inventions in that the teacher signal is any one of a squared error (_{T}*-_{T})² of present torque _{T} with respect to a torque command value _{T}*, a squared error (iₚ*-iₚ)² of a current peak value iₚ with respect to a current peak command value iₚ*, and a squared error (i_{q}*-i_{q})² of a q-axis current i_{q} with respect to a q-axis current command value i_{q}*.

The motor control device according to the invention of claim 6 is characterized in the invention of claim 1 in that the neural network compensator uses the current peak command value iₚ* and the current peak value iₚ as input signals, uses the squared error (iₚ*-iₚ)² of the current peak value iₚ with respect to the current peak command value iₚ* as a teacher signal, and uses the current phase command value θᵢ* as an output signal so as to derive the output signal from the input signals in a learning manner such that the teacher signal is minimized.

The motor control device according to the invention of claim 7 is characterized in the invention of claim 1 in that the neural network compensator uses the q-axis current command value i_{q}* and the q-axis current i_{q} as input signals, uses the squared error (i_{q}*-i_{q})² of the q-axis current i_{q} with respect to the q-axis current command value i_{q}* as a teacher signal, and uses the current phase command value θᵢ* as an output signal so as to derive the output signal from the input signals in a learning manner such that the teacher signal is minimized.

The motor control device according to the invention of claim 8 is characterized in the invention of claim 1 in that the neural network compensator uses the current peak value iₚ, the d-axis inductance L_{d}, the q-axis inductance L_{q}, and the magnetic flux density φ as input signals, uses the squared error (_{T}*-_{T})² of the present torque _{T} with respect to the torque command value _{T}* as a teacher signal, and uses the current peak command value iₚ* and/or the current phase command value θᵢ* as an output signal so as to derive an output signal from the input signals in a learning manner such that the teacher signal is minimized.

The motor control device according to the invention of claim 9 is characterized in the invention of claim 1 in that the neural network compensator uses the torque command value _{T}* and the present torque _{T} as input signals, uses the squared error (_{T}*-_{T})² of the present torque _{T} with respect to the torque command value _{T}* as a teacher signal, and uses the current peak command value iₚ* and/or the current phase command value θ₁* as the output signal so as to derive the output signal from the input signals in a learning manner such that the teacher signal is minimized.

The motor control device according to the invention of claim 10 is characterized in each of the above-described inventions in that the motor is a permanent-magnet synchronous motor.

The motor control device according to the invention of claim 11 is characterized in each of the above-described inventions by including: a motor drive unit that drives and controls a motor; and a motor control unit that controls the motor by the motor drive unit on the basis of an output signal of the neural network compensator.

### Advantageous Effect of the Invention

The motor control device according to the present invention is provided with a neural network compensator that receives an input signal and repeats learning based on forward propagation and backpropagation thereby to derive an output signal providing optimal efficiency. The input signal is any one of, a combination of, or all of a motor current, a motor parameter, and torque, and the output signal is a current command value and/or a current phase command value, and the motor is controlled on the basis of an output signal derived by the neural network compensator. Therefore, it is possible to minimize losses in real time and prevent deterioration of efficiency even if there are product variations of motors or motor parameters change due to aging or temperature changes in addition to magnetic saturation.

Thus, it is possible to adopt inexpensive motors, which have more variations, and to also significantly reduce the man-hours required to adapt parameters, reduce cost, and achieve so-called robustness.

In this case, as in the invention of claim 2, any one of, or a combination of, or all of the q-axis current command value i_{q}*, the q-axis current i_{q}, the current peak command value iₚ*, the current peak value iₚ, the d-axis inductance L_{d}, the q-axis inductance L_{q}, the magnetic flux density φ, the torque command value τ*, and the present torque _{T} can be adopted as the input signals for the neural network compensator.

Further, as in the invention of claim 3, the current peak command value iₚ* and/or the current phase command value θᵢ* can be adopted as the output signal of the neural network compensator.

Further, as in the invention of claim 4, if the neural network compensator uses a squared torque error or a squared current error as a teacher signal and derives an output signal from an input signal in a learning manner such that the teacher signal is minimized, then a motor can be accurately controlled in a state of optimum efficiency.

In this case, as in the invention of claim 5, any one of the squared error (_{T}*-_{T})² of the present torque _{T} with respect to the torque command value τ*, the squared error (iₚ*-iₚ)² of the current peak value iₚ with respect to the current peak command value iₚ*, and a squared error (i_{q}*-i_{q})² of the q-axis current i_{q} with respect to the q-axis current command value i_{q}* can be adopted as the teacher signal for the neural network compensator.

Further, as in the invention of claim 6, if the neural network compensator uses the current peak command value iₚ* and the current peak value iₚ as input signals, uses the squared error (iₚ*-iₚ)² of the current peak value iₚ with respect to the current peak command value iₚ* as a teacher signal, and uses the current phase command value θᵢ* as an output signal so as to derive the output signal from the input signals in a learning manner such that the teacher signal is minimized, then motor control at optimal efficiency can be achieved even in the case where torque cannot be detected.

The same applies to a case where, as in the invention of claim 7, the neural network compensator uses the q-axis current command value i_{q}* and the q-axis current i_{q} as input signals, uses the squared error (i_{q}*-i_{q})² of the q-axis current i_{q} with respect to the q-axis current command value i_{q}* as a teacher signal, and uses the current phase command value θᵢ* as an output signal so as to derive the output signal from the input signals in a learning manner such that the teacher signal is minimized.

Further, as in the invention of claim 8, if the neural network compensator uses the current peak value iₚ, the d-axis inductance L_{d}, the q-axis inductance L_{q}, and the magnetic flux density φ as input signals, uses the squared error (_{T}*-_{T})² of the present torque _{T} with respect to the torque command value _{T}* as a teacher signal, and uses the current peak command value iₚ* and/or the current phase command value θᵢ* as an output signal so as to derive the output signal from the input signals in a learning manner such that the teacher signal is minimized, then motor control at optimum efficiency can be effectively achieved in the case where torque can be detected.

The same applies to a case where, as in the invention of claim 9, the neural network compensator uses the torque command value _{T}* and the present torque _{T} as input signals, uses the squared error (_{T}*-_{T})² of the present torque _{T} with respect to the torque command value _{T}* as a teacher signal, and uses the current peak command value iₚ* and/or the current phase command value θᵢ* as an output signal so as to derive the output signal from the input signals in a learning manner such that the teacher signal is minimized.

Further, each of the above-described inventions is effective for the permanent-magnet synchronous motor as in the invention of claim 10, and is adapted to control a motor specifically by further including a motor drive unit for driving and controlling a motor and a motor control unit for controlling the motor through the motor drive unit on the basis of the output signals of the neural network compensator, as in the invention of claim 11.

### BRIEF DESCRIPTION OF THE DRAWINGS

FIG. 1 is a block diagram of a motor control device of an embodiment to which the present invention has been applied (Embodiment 1-1).

FIG. 2 is a block diagram of the neural network compensator of the motor control device in FIG. 1.

FIG. 3 presents diagrams illustrating an example of the internal structure of the neural network compensator in FIG. 2.

FIG. 4 is a block diagram of a motor control device of another embodiment to which the present invention has been applied (Embodiment 1-2).

FIG. 5 is a block diagram of the neural network compensator of the motor control device in FIG. 4.

FIG. 6 is a diagram illustrating the speed response waveforms of the case in FIG. 4.

FIG. 7 is a diagram illustrating the torque response waveforms of the case in FIG. 4.

FIG. 8 presents diagrams illustrating the current response waveforms of the case in FIG. 4.

FIG. 9 presents diagrams illustrating power loss and energy loss of the case in FIG. 4.

FIG. 10 is a diagram illustrating the speed response waveforms of the case in FIG. 1.

FIG. 11 is a diagram illustrating the torque response waveforms of the case in FIG. 1.

FIG. 12 presents diagrams illustrating the current response waveforms of the case in FIG. 1.

FIG. 13 presents diagrams illustrating power loss and energy loss of the case in FIG. 1.

FIG. 14 is a diagram illustrating the speed response waveforms of the case in FIG. 1 and FIG. 4 when motor parameters change.

FIG. 15 is a diagram illustrating the torque response waveforms of the cases in FIG. 1 and FIG. 4 when the motor parameters change.

FIG. 16 presents diagrams illustrating the current response waveforms in the case of FIG. 1 and FIG. 4 when the motor parameters change.

FIG. 17 presents diagrams illustrating power loss and energy loss of the cases in FIG. 1 and FIG. 4 when the motor parameters change.

FIG. 18 is a block diagram of a neural network compensator of still another embodiment to which the present invention has been applied (Embodiment 2-1).

FIG. 19 is a block diagram of a neural network compensator of yet another embodiment to which the present invention has been applied (Embodiment 2-2).

FIG. 20 is a block diagram of a neural network compensator of a further embodiment to which the present invention has been applied (Embodiment 2-3).

FIG. 21 is a block diagram of a neural network compensator of a still further embodiment to which the present invention has been applied (Embodiment 3-1).

FIG. 22 is a block diagram of a neural network compensator of a yet further embodiment to which the present invention has been applied (Embodiment 3-2).

FIG. 23 is a block diagram of a neural network compensator of still another embodiment to which the present invention has been applied (Embodiment 3-3).

### MODE FOR CARRYING OUT THE INVENTION

The following will describe in detail the embodiments of the present invention with reference to the accompanying drawings.

### Embodiment 1

### Motor Control Device 1

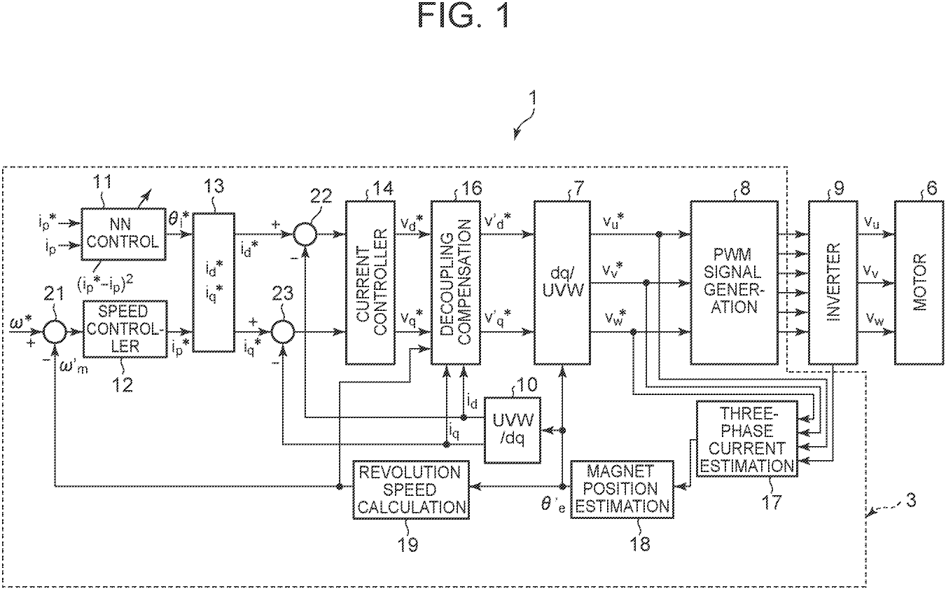

FIG. 1 is a block diagram illustrating the configuration of a motor control device 1 of an embodiment of the present invention. The motor control device 1 of the embodiment includes an inverter circuit 9 and a motor control unit 3, and is configured to convert and generate AC power of a predetermined frequency and to supply the generated AC power to a motor 6. The motor 6 is a three-phase interior permanent-magnet motor for driving an electric compressor used in an air conditioner of an electromotive vehicle such as, for example, an electric vehicle or a hybrid vehicle. The embodiment adopts a permanent-magnet synchronous motor (IPMSM: Interior Permanent Magnet Synchronous Motor), which is driven by the inverter circuit 9 according to voltage commands generated by the motor control unit 3.

### Inverter Circuit 9

The inverter circuit 9 is configured by a plurality of (six) bridge-connected switching elements. Each switching element of the inverter circuit 9 is switched by a PWM signal generated by a PWM signal generator 8 of the motor control unit 3, which will be described later.

### Motor Control Unit 3

The motor control unit 3 in the embodiment is adapted to generate a d-axis voltage command value Vd* and a q-axis voltage command value Vq* in a direction for eliminating a difference between an estimated mechanical angular velocity value ω′ₘ and a mechanical angular velocity command value ω* of the motor 6 on the basis of the difference therebetween, and eventually generate a PWM signal for switching each switching element of the inverter circuit 9 by using the PWM signal generator 8 on the basis of the d-axis voltage command value Vd* and the q-axis voltage command value Vq* so as to drive the motor 6 by sensorless vector control. The means for controlling the motor 6 is not limited to the sensorless control, but a position sensor may be used.

The motor control unit 3 of this embodiment is composed of a microcomputer, which is an example of a computer provided with a processor, and includes, as the functions thereof, a neural network compensator 11, a speed controller 12, a converter 13, a current controller 14, a decoupling compensator 16, a phase voltage command calculator 7, the PWM signal generator 8, a dq-axis current converter 10, a three-phase current estimator 17, a magnet position estimator 18, a revolution speed calculator 19, and the like.

The three-phase current estimator 17 estimates each phase current (U-phase current iᵤ, V-phase current iᵥ, and W-phase current i_{w}) from each phase voltage output by the phase voltage command calculator 7, namely, a U-phase voltage command value Vᵤ*, a V-phase voltage command value Vᵥ* and a W-phase voltage command value V_{w}* (the six PWM signals generated by the PWM signal generator 8 may alternatively be used), and the phase current of one phase passing through the inverter circuit 9 detected by one shunt resistor (one-shunt current detection method). Other possible methods of detecting the current of each phase include a two-shunt current detection method in which two shunt resistors are used to detect the phase currents of two phases, a three-shunt current detection method in which three shunt resistors are used to detect the phase currents of three phases, and a Hall CT current detection method in which a Hall CT is used to detect phase currents.

The magnet position estimator 18 in this embodiment estimates an estimated electrical angle value θ′ₑ from each phase current, namely, the U-phase current iᵤ, the V-phase current iᵥ, and the W-phase current i_{w}, output by the three-phase current estimator 17. Other than these, the U-phase voltage command value Vᵤ*, the V-phase voltage command value Vᵥ* and the W-phase voltage command value V_{w}* may be used, and the d-axis voltage command value Vd* and the q-axis voltage command value Vq* may be used for estimating the estimated electrical angle value θ′ₑ. Further, the d-axis voltage command value Vd*, the q-axis voltage command value Vq*, the d-axis current i_{d}, and the q-axis current i_{q} may be used. In addition, any one of or a combination of, or all of the U-phase current iᵤ, the V-phase current iᵥ, the W-phase current i_{w}, the U-phase voltage command value Vᵤ*, the V-phase voltage command value Vᵥ* the W-phase voltage command value V_{w}*, the d-axis voltage command value V_{d}^{∗}, the q-axis voltage command value V_{q}^{∗}, the d-axis current i_{d}, and the q-axis current i_{q} may be used to estimate the estimated electrical angle value θ′ₑ. Further, the revolution speed calculator 19 estimates the aforementioned estimated mechanical angular velocity value ω′ₘ from the estimated electrical angle value θ′ₑ output by the magnet position estimator 18. Further, the dq-axis current converter 10 derives the d-axis current i_{d} and the q-axis current i_{q} from the estimated electrical angle value θ′ₑ output by the magnet position estimator 18. In addition, the estimated electrical angle value θ′ₑ output by the magnet position estimator 18 is further input to the phase voltage command calculator 7, and the d-axis current i_{d} and the q-axis current i_{q} output by the dq-axis current converter 10 and the estimated mechanical angular velocity value ω′ₘ output by the revolution speed calculator 19 are input to the decoupling compensator 16. In addition, the estimated mechanical angular velocity value ω′ₘ output by the revolution speed calculator 19 is further input to a subtractor 21. The mechanical angular velocity command value ω^{∗} is input to the subtractor 21, and the estimated mechanical angular velocity value ω′ₘ is subtracted from the mechanical angular velocity command value ω^{∗} in the subtractor 21 to calculate the difference therebetween. In the case where the position sensor is used to control the motor 6 as described above, the mechanical angular velocity (ω) detected by the position sensor is input, in place of the estimated mechanical angular velocity value ω′ₘ, to the subtractor 21.

The difference calculated by the subtractor 21 is input to the speed controller 12. The speed controller 12 calculates the current peak command value iₚ^{∗} by PI calculation and the relational expression of the current peak value iₚ and torque. Instead of the calculation based on such an expression, a map set offline on the basis of the relationship between the current peak value iₚ and torque may be used to calculate the current peak command value iₚ^{∗}. Further, when using the expression, parameters may be identified or estimated online to improve accuracy. The current peak command value iₚ^{∗} is input as the other input to the converter 13. The current phase command value θ₁^{∗} output by the neural network compensator 11 is input to one input of the converter 13. The neural network compensator 11 will be described in detail later.

The converter 13 derives the d-axis current command value i_{d}^{∗} and the q-axis current command value i_{q}^{∗} from the current phase command value θ₁^{∗} and the current peak command value iₚ^{∗}. The converter 13 derives the d-axis current command value i_{d}^{∗} and the q-axis current command value i_{q}^{∗} according to expression (1) given below. [Math. 1]

$$\left\{\begin{matrix}{\text{i}}_{\text{d}} * = {\text{-i}}_{\text{p}} \text{*sin} {θ}_{\text{i}} \text{*} \\ {\text{i}}_{\text{q}} \text{*} \text{=} {\text{i}}_{\text{p}} \text{*cos} {θ}_{\text{i}} \text{*}\end{matrix}\right) \qquad \text{(I)}$$

The d-axis current command value i_{d}^{∗} and the q-axis current command value i_{q}^{∗} output by the converter 13 are input to subtractors 22 and 23, respectively. The d-axis current i_{d} and the q-axis current i_{q} output by the dq-axis current converter 10 are input to the subtractors 22 and 23, respectively, and the differences are calculated in the subtractors 22 and 23.

The differences output by the subtractors 22 and 23 are input to the current controller 14. The current controller 14 performs the PI calculation by using the differences to generate and output the d-axis voltage command value V_{d}^{∗} and the q-axis voltage command value V_{q}^{∗}. These d-axis voltage command value V_{d}^{∗} and the q-axis voltage command value V_{q}^{∗} are input to the phase voltage command calculator 7 after the decoupling compensator 16 cancels the interference between the d- and q- axes (the outputs being denoted by V′_{d}^{∗} and V′_{q}^{∗} in FIG. 1). The decoupling compensator 16 may be omitted.

Based on the d-axis voltage command value V’_{d}^{∗} and the q-axis voltage command value V′_{q}^{∗}, and the estimated electrical angle value θ′ₑ output by the magnet position estimator 18, the phase voltage command calculator 7 generates the U-phase voltage command value Vᵤ^{∗}, the V-phase voltage command value Vᵥ^{∗}, and the W-phase voltage command value V_{w}^{∗}, and outputs the generated voltage command values to the PWM signal generator 8. Based on the voltage command values Vᵤ^{∗}, Vᵥ^{∗}, and V_{w}^{∗} of the individual phases, the PWM signal generator 8 generates PWM signals for switching (PWM controlling) the switching elements of the inverter circuit 9. Then, the phase voltages Vu, Vv, and Vw are applied to the motor 6 from the inverter circuit 9, thus achieving the sensorless vector control of the motor 6 in the embodiment.

### Neural Network Compensator 11 (Embodiment 1-1)

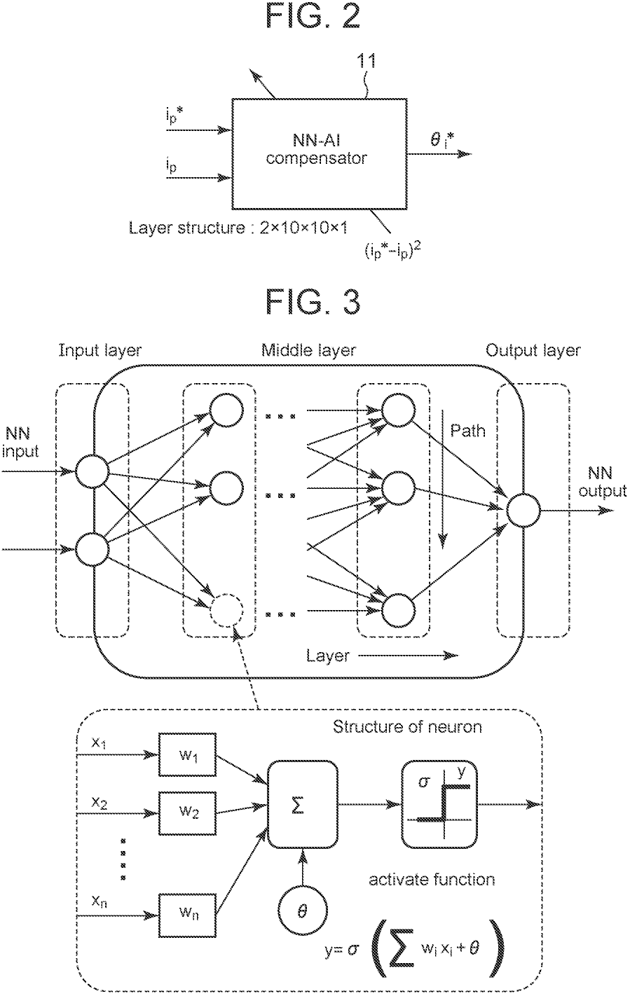

Referring now to FIG. 2 and FIG. 3, the neural network compensator 11 in FIG. 1 will be described in detail. FIG. 2 is a block diagram of the neural network compensator 11 of the embodiment, and FIG. 3 presents diagrams illustrating the internal structure of the neural network compensator 11. The neural network compensator 11 is adapted to receive input signals and repeats learning based on forward propagation and backpropagation to derive output signals providing optimal efficiency.

The output signals can be the current peak command value iₚ^{∗} (the command value of the current peak value iₚ) and the current phase command value θ₁^{∗} that provide optimal efficiency. The input signals can be the current peak value iₚ that influences an output, the d-axis inductance L_{d}, the q-axis inductance L_{q}, and the interlinkage magnetic flux φ, which are the parameters of the motor 6 (motor parameters) to be controlled. Additional input signals can be the torque command value τ^{∗} and the present torque τ. Further, the teacher signals to be minimized can be the squared error (τ^{∗}-τ)² of the present torque τ with respect to the torque command value τ^{∗}, the squared error (iₚ^{∗}-iₚ)² of the current peak value iₚ with respect to the current peak command value iₚ^{∗}, and the squared error (i_{q}^{∗}-i_{q})² of the q-axis current i_{q} with respect to the q-axis current command value i_{q}^{∗}.

The neural network compensator 11 of the embodiment (Embodiment 1-1) in FIG. 1 and FIG. 2 uses the current peak command value iₚ^{∗} and the current peak value iₚ as the input signals, and uses the squared error (iₚ^{∗}-iₚ)² of the current peak value iₚ with respect to the current peak command value iₚ^{∗} as the teacher signal. Then, using the current phase command value θ₁^{∗} as the output signal, the output signal is derived in a learning manner from the input signals such that the teacher signal is minimized.

In other words, in order to derive the current phase command value θ₁^{∗} providing optimal efficiency, the current peak command value iₚ^{∗} and the current peak value iₚ are used as the input signals, and the squared error (iₚ^{∗}-iₚ)² of the current peak value iₚ with respect to the current peak command value iₚ^{∗} is used as the teacher signal to be minimized. The neural network compensator 11 is a multilayer neural network compensator, and repeats learning based on forward propagation and backpropagation to derive the current phase command value θ₁^{∗} that is optimal for minimizing the teacher signal in real time.

The embodiment in FIG. 1 and FIG. 2 illustrates a control technique in which a target input (or an output of the speed controller 12) is regarded as the current peak value iₚ (i_{d} being not 0), and which is considered to be a control method more suitable for controlling the motor 6 composed of the permanent magnet synchronous motor of the embodiment. The control technique is particularly effective when used in the case where the present torque τ cannot be detected or when used in a speed control system. The speed of the motor 6 is controlled in a state of optimal efficiency by using an optimal current phase command value θ₁^{∗} calculated together with the current peak value iₚ.

Referring now to the internal structure illustrated in FIG. 3, the neural network compensator 11 will be described more specifically. The neural network compensator 11 derives in a learning manner a compensation amount (output signal) from a present input signal such that the teacher signal (the squared error (iₚ^{∗}-iₚ)² of the current peak value iₚ with respect to the current peak command value iₚ^{∗}) is minimized. In other words, the compensation amount for the current peak command value iₚ^{∗} (required current peak value) with respect to the present current peak value iₚ (current phase command value θᵢ^{∗}: output signal) is derived by information updating from currently available information (the current peak command value iₚ^{∗} and the current peak value iₚ: input signals) for every calculation period.

The internal structure of the neural network (NN) compensator 11 is as illustrated in FIG. 3 (an example of two inputs and one output in FIG. 3). There are a plurality of layers (middle layers) between an input layer and an output layer, and each layer is composed of neurons, and the neurons before and after are connected by synapses (weights). The join expression for each neuron is Expression (II). The neural network compensator 11 of the embodiment has an input layer (two inputs), two layers (ten neurons), three layers (ten neurons), and an output layer (one output). [Math. 2]

$$\text{y=} σ \left(\sum {\text{w}}_{\text{i}} {\text{x}}_{\text{i}} + θ\right) \qquad \text{(I)}$$

where wᵢ denotes a weight, θ denotes a threshold value, and σ denotes an activation function in Expression (II). Further, an update expression (learning expression) of the weight wᵢ and the threshold value θ is Expression (III). [Math. 3]

$$\begin{matrix}{\text{w}}_{\text{i}} \left(\text{t+1}\right) = {\text{w}}_{\text{i}} \left(\text{t}\right) - α \frac{\partial \text{E} \left(\text{t}\right)}{\partial {\text{w}}_{\text{i}}} \\ θ \left(\text{t+1}\right) = θ \left(\text{t}\right) - α \frac{\partial \text{E} \left(\text{t}\right)}{\partial θ}\end{matrix} \qquad \text{(III)}$$

where α denotes a learning rate, and E denotes a loss function (the sum of squared errors) in Expression (III).

### Neural Network Compensator 11 (Embodiment 1-2)

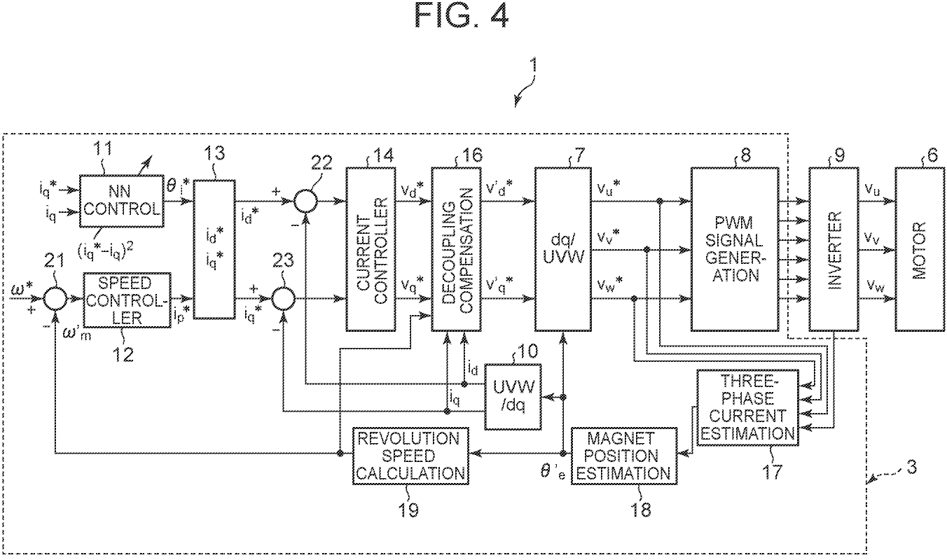

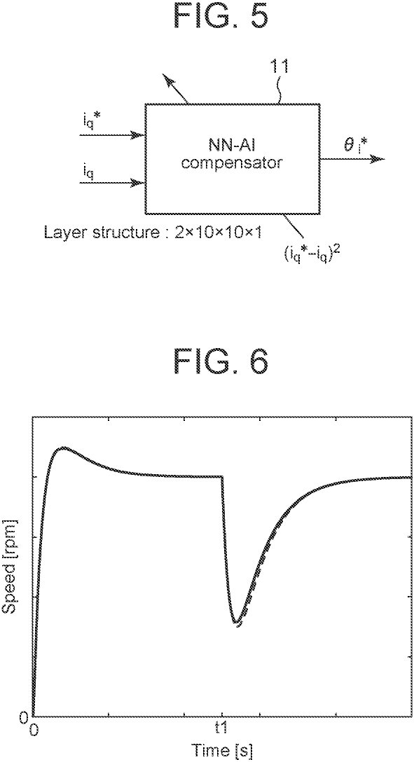

Referring now to FIG. 4 and FIG. 5, the case where the neural network compensator 11 of another embodiment is used will be described. FIG. 4 is a block diagram of a motor control device 1 in this case, and FIG. 5 is a block diagram of the neural network compensator 11 of this embodiment. In each drawing, constituent elements denoted by the same reference numerals as those in FIG. 1 and FIG. 2 are assumed to exhibit the same or similar functions.

The neural network compensator 11 of the embodiment (Embodiment 1-2) of FIG. 4 and FIG. 5 uses the q-axis current command value i_{q}^{∗} and the q-axis current i_{q} as input signals, and uses the squared error (i_{q}^{∗}-i_{q})² of the q-axis current i_{q} with respect to the q-axis current command value i_{q}^{∗} as a teacher signal. Then, with the current phase command value θ₁^{∗} as the output signal, the neural network compensator 11 derives, in a learning manner, the output signal from the input signals such that the teacher signal is minimized.

In other words, in order to derive the current phase command value θ₁^{∗} providing optimal efficiency, the q-axis current command value i_{q}^{∗} and the q-axis current i_{q} are used as the input signals, and the squared error (i_{q}^{∗}-i_{q})² of the q-axis current i_{q} with respect to the q-axis current command value i_{q}^{∗} is used as the teacher signal to be minimized. The neural network compensator 11 in this embodiment is also a multilayer neural network compensator, and repeats learning based on forward propagation and backpropagation to derive the current phase command value θ₁^{∗} that is optimal for minimizing the teacher signal in real time.

The embodiment of FIG. 4 and FIG. 5 illustrates a case where the control is performed, regarding a target input (or the output of the speed controller 12) as the q-axis current i_{q} (torque current). This is a control method (i_{d}=0) for a motor of surface magnet type (SPM). This is also effectively used in the case where the present torque τ cannot be detected, or when used with a speed control system, and controls the speed of the motor 6 in a state of optimal efficiency by using an optimal current phase command value θᵢ^{∗} calculated together with the current peak value iₚ.

### Evaluating the Motor Control Devices 1 in FIG. 1 to FIG. 5

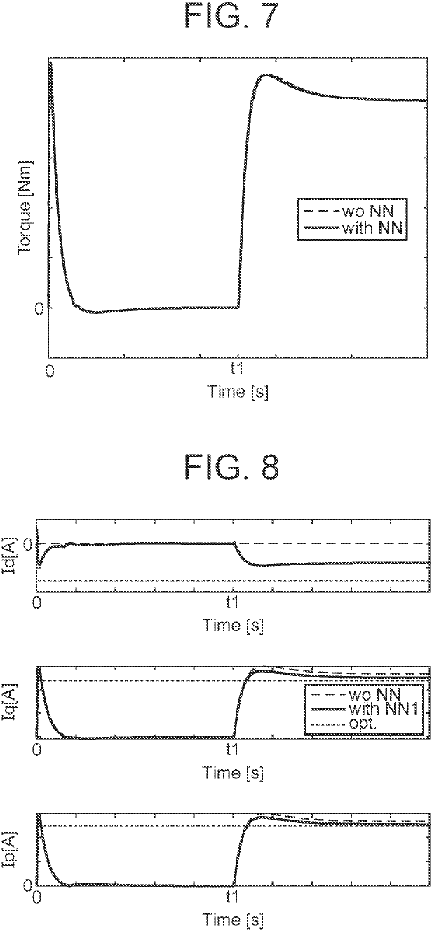

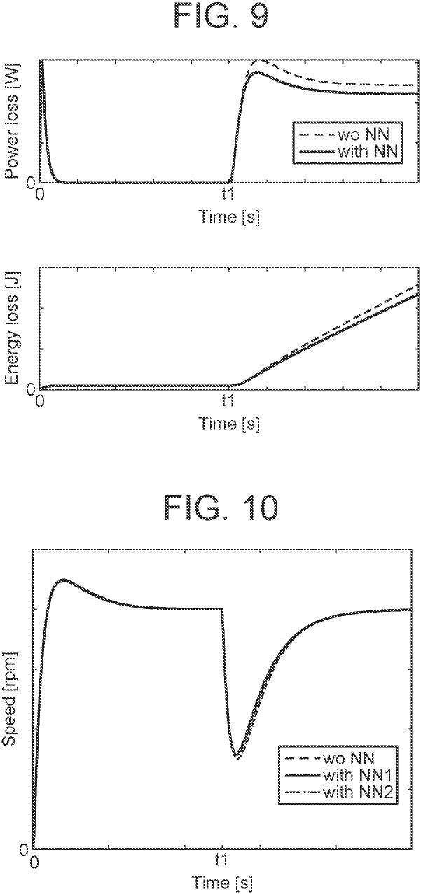

Referring now to FIG. 6 to FIG. 17, the effect of the optimal efficiency control of the motor 6 by using the neural network compensator 11 described above with reference to FIG. 1 to FIG. 5 will be described. First, FIG. 6 illustrates a speed response waveform when a step command is applied at time 0 s and a torque disturbance is applied at time t1 in the case of the example (Embodiment 1-2) in FIG. 4 (FIG. 5). FIG. 7 illustrates torque response waveforms in the same case, FIG. 8 illustrates current response waveforms in the same case, and FIG. 9 illustrates power loss and energy loss in the same case. In this case, the output (current command) of the speed controller 12 is regarded as i_{q}^{∗} in the evaluation.

In FIG. 6 and FIG. 7, the solid lines indicate the case of the motor control device 1 using the neural network compensator 11 (NN), and the dashed lines indicate the case of a general motor control system not using a neural network compensator (NN) (a method not involving the neural network compensator 11 and the converter 13 in FIG. 1 and FIG. 4, the rest of the configuration being the same, and the control being performed with i_{d}=0). In FIG. 6 and FIG. 7, no significant difference is observed in both the speed response and the torque response.

Meanwhile, in the current response waveforms of FIG. 8, the solid lines indicate the case of the motor control device 1 using the neural network compensator 11 (NN), and the wide dashed lines indicate the case of a general motor control system not using the neural network compensator (NN). Further, the fine dashed lines indicate optimal current values. The optimal current values are to be determined in advance by experiments or simulations.

In the general motor control system not using a neural network compensator, the d-axis current i_{d} was zero in a steady state when a torque disturbance was applied. In contrast, it can be verified that the motor control device 1 in FIG. 4 (FIG. 5) using the neural network compensator 11 can learn such that all the d-axis current i_{d}, the q-axis current i_{q} and the current peak value iₚ are close to optimal current values.

Further, FIG. 9 illustrates power loss on the upper side and energy loss on the lower side. The solid lines indicate the case of the motor control device 1 using the neural network compensator 11 (NN), and the dashed lines indicate the case of a general motor control system not using the neural network compensator (NN). From FIG. 9, it can be verified that the motor control device 1 using the neural network compensator 11 (NN) in FIG. 4 (FIG. 5) can improve the both losses when a torque disturbance is applied, as compared with a conventional motor control system.

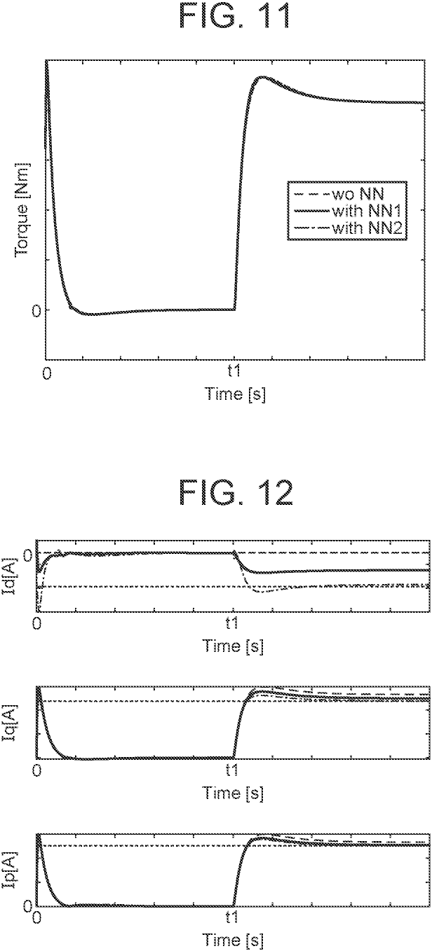

Next, FIG. 10 illustrates speed response waveforms when a step command is applied at time 0 s and a torque disturbance is applied at time t1 in the case of the example (Embodiment 1-1) in FIG. 1 (FIG. 2). FIG. 11 illustrates torque response waveforms of the same example, FIG. 12 illustrates current response waveforms of the same example, and FIG. 13 illustrates power loss and energy loss of the same example. In this case, the output (current command) of the speed controller 12 is regarded as iₚ^{∗} in the evaluation.

In FIG. 10 and FIG. 11, the solid lines indicate the case of the motor control device 1 using a neural network compensator 11 (NN1) in FIG. 4 (FIG. 5), the one-dot chain line indicates the case of the motor control device 1 using a neural network compensator 11 (NN2) in FIG. 1 (FIG. 2), and the dashed lines indicate the case of a general motor control system not using the neural network compensator (NN) as described above.

Regarding the speed response in FIG. 10, the amount of overshoot with respect to a target value can be slightly improved in the case of FIG. 1 (FIG. 2) (the one-dot chain line) over the case of FIG. 4 (FIG. 5) (the solid line) or the general motor control system (the dashed line), and the amount of drop in the disturbance response can be also reduced. Regarding the torque response in FIG. 11, the torque at the time of target input increases more in the case of FIG. 1 (FIG. 2) (the one-dot chain line) than in the case of FIG. 4 (FIG. 5) (the solid line) or in the case of the general motor control system (the dashed line), and the response to a disturbance is substantially the same.

Meanwhile, regarding the current response waveforms in FIG. 12, the solid lines indicate the case of the motor control device 1 using the neural network compensator 11 (NN1) in FIG. 4 (FIG. 5), the one-dot chain lines indicate the case of the motor control device 1 using the neural network compensator 11 (NN2) in FIG. 1 (FIG. 2), and the wide dashed lines indicate the case of a general motor control system not using the neural network compensator (NN). Further, the fine dashed lines indicate optimal current values.

It can be verified that the motor control device 1 (the one-dot chain lines) using the neural network compensator 11 in FIG. 1 (FIG. 2) can learn to bring the values of all the d-axis current i_{d}, the q-axis current i_{q}, and the current peak value iₚ closer to the optimal current values (the fine dashed lines) than the motor control device 1 (the solid lines) using the neural network compensator 11 in FIG. 4 (FIG. 5).

Further, FIG. 13 illustrates power loss on the upper side and energy loss on the lower side. In this case also, the solid lines indicate the case of the motor control device 1 using the neural network compensator 11 (NN1) in FIG. 4 (FIG. 5), the one-dot chain lines indicate the case of the motor control device 1 using the neural network compensator 11 (NN2) in FIG. 1 (FIG. 2), and the wide dashed lines indicate the case of a general motor control system not using the neural network compensator (NN).

From the results of the power loss on the upper side of the diagram, it can be verified that, at a steady-state value when a step torque disturbance is applied, the motor control device 1 (the one-dot chain line) using the neural network compensator 11 (NN2) in FIG. 1 (FIG. 2) can improve most. In addition, regarding the energy loss on the lower side, it can be verified that the motor control device 1 (the one-dot chain line) using the neural network compensator 11 in FIG. 1 (FIG. 2) exhibits further improvement, as compared with the motor control device 1 (the solid line) using the neural network compensator 11 (NN1) in FIG. 4 (FIG. 5).

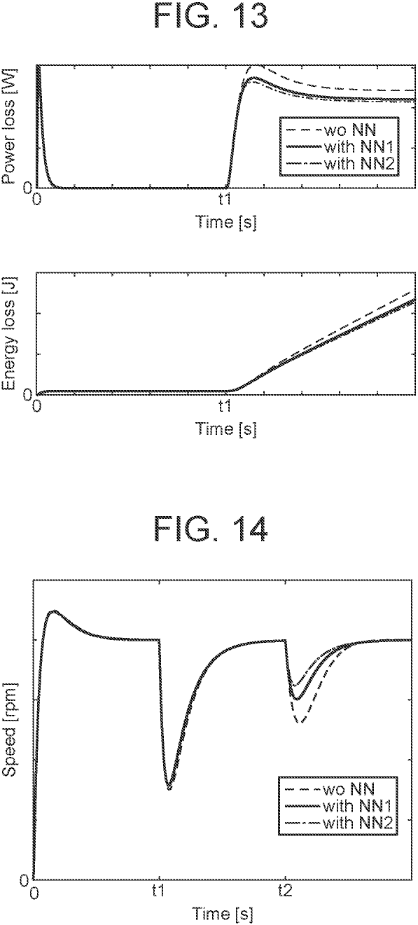

Referring now to FIG. 14 to FIG. 17, the improvement of efficiency when the parameters (motor parameters) of the motor 6 (object to be controlled) change will be verified. Of the motor parameters in this case, the variation parameters (the parameters to be changed) are the d-axis inductance L_{d}, the q-axis inductance L_{q}, and the magnetic flux density φ. Each of the values after changing the parameters was multiplied by a multiplier of a mean value of 1 and a standard deviation of 0.5/3, and one combination reducing the torque most by 10⁵ random number calculations was selected. Further, as the simulation conditions, the step command was applied at time 0 s, the step torque disturbance was applied at time t1 in the same manner as described above, and then the parameters (motor parameters) of the motor 6 (the object to be controlled) were changed at time t2.

FIG. 14 and FIG. 15 illustrate the response waveforms of speed and torque. In each of the diagrams, the solid lines indicate the case of the motor control device 1 using the neural network compensator 11 (NN1) in FIG. 4 (FIG. 5), the one-dot chain lines indicate the case of the motor control device 1 using the neural network compensator 11 (NN2) in FIG. 1 (FIG. 2), and the dashed lines indicate the case of a general motor control system not using the neural network compensator (NN) in the same manner as described above.

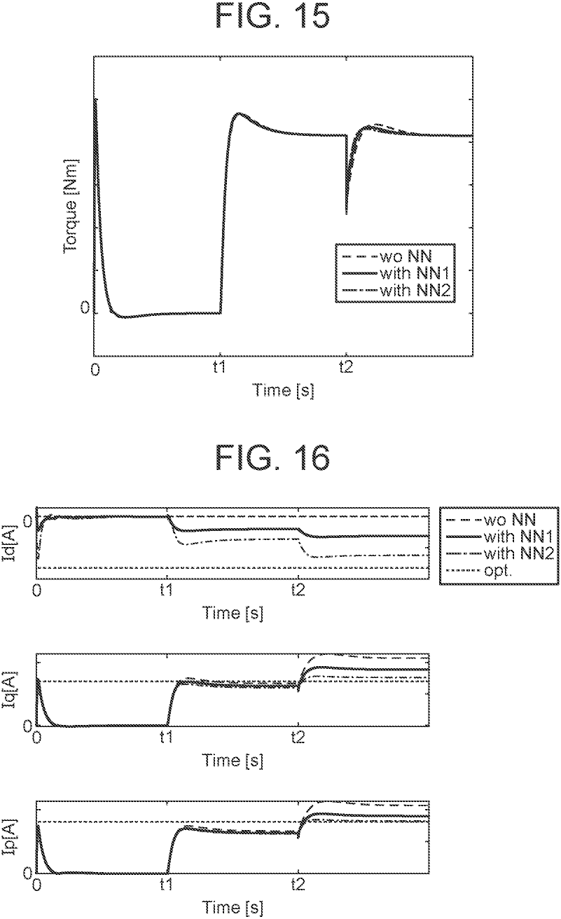

Further, FIG. 16 and FIG. 17 illustrate the current response waveforms and losses. In each of the diagrams, the solid lines indicate the case of the motor control device 1 using the neural network compensator 11 (NN1) in FIG. 4 (FIG. 5), the one-dot chain lines indicate the case of the motor control device 1 using the neural network compensator 11 (NN2) in FIG. 1 (FIG. 2), and the wide dashed lines indicate the case of a general motor control system not using the neural network compensator (NN) in the same manner as described above. Further, FIG. 16 indicates, by fine dashed lines, the optimal current values required for compensating for disturbance torque when the motor parameters are changed.

From the results of FIG. 16, it can be verified that, in response to changes of motor parameters, the values are closer to the optimum current values in the order of a general motor control system not using the neural network compensator (NN) (the wide dashed line), the motor control device 1 using the neural network compensator 11 (NN1) in FIG. 4 (FIG. 5) (the solid line), and the motor control device 1 using the neural network compensator 11 (NN2) in FIG. 1 (FIG. 2) (the one-dot line).

Further, from the results of the power loss (copper loss) on the upper side of FIG. 17, it can be verified that, in terms of the net power loss after subtracting the power loss for the disturbance in the steady-state loss of motor parameter changes, the motor control device 1 using the neural network compensator 11 (NN1) in FIG. 4 (FIG. 5) (the solid lines) can achieve improvements in contrast to the general motor control system not using the neural network compensator (NN) (the wide dashed lines), and further, the motor control device 1 using the neural network compensator 11 (NN2) in FIG. 1 (FIG. 2) (one-dot chain lines) can achieve significant improvements.

Thus, it can be verified from FIG. 14 that, in addition to the loss improvement, the response characteristics can be improved to be the same or even better than those by general motor control systems. In other words, it can be verified that the motor control device 1 using the neural network compensator 11 (NN2) in FIG. 1 (FIG. 2) significantly suppresses loss in the quantitative evaluation in the steady state for speed command, torque disturbance, and motor parameter changes, as compared with general motor control systems.

### Embodiment 2

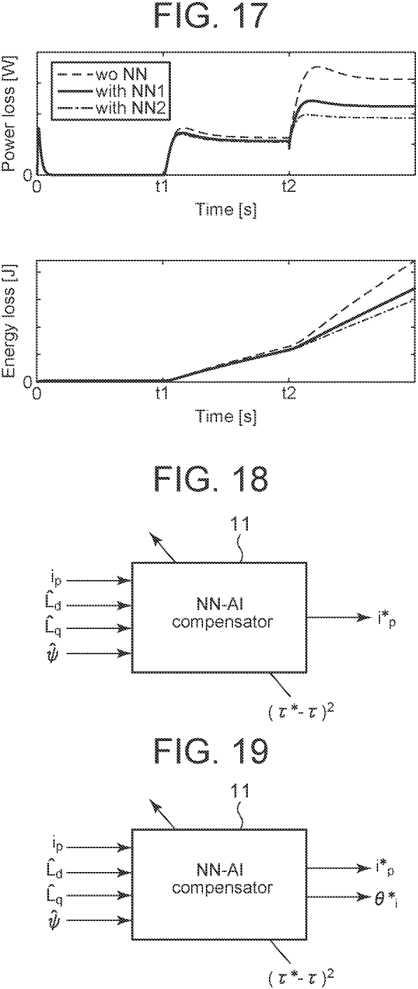

Referring now to FIG. 18 to FIG. 20, a neural network compensator 11 of a still another embodiment will be described. As with the neural network compensator 11 in FIG. 1 and FIG. 4, the output signals of the neural network compensator 11 of this embodiment will be the inputs to one end of a converter 13 and constitute a part of a motor control device 1.

### Neural Network Compensator 11 (Embodiment 2-1)

A neural network compensator 11 of the embodiment (Embodiment 2-1) in FIG. 18 uses a current peak value iₚ, and a d-axis inductance L_{d} (hat), a q-axis inductance L_{q} (hat), and an interlinkage magnetic flux φ (hat), which are motor parameters, as input signals, and uses the squared error (τ^{∗}-τ)² of present torque τ with respect to a torque command value τ^{∗} as a teacher signal. Then, with a current peak command value iₚ^{∗} being an output signal, the output signal is derived from the input signals in a learning manner such that the teacher signal is minimized.

In other words, in this case, in order to derive the current peak command value iₚ^{∗} that provides optimal efficiency for torque control, the current peak value iₚ, the d-axis inductance L_{d} (hat), the q-axis inductance L_{q} (hat), and the interlinkage magnetic flux φ (hat) are used as the input signals, and the squared error (τ^{∗}-τ)² of the present torque τ with respect to the torque command value τ^{∗} is used as the teacher signal to be minimized. The neural network compensator 11 of this embodiment is also a multilayer neural network compensator, and repeats learning based on forward propagation and backpropagation to derive the current peak command value iₚ^{∗} that is optimal for minimizing the teacher signal in real time.

### Neural Network Compensator 11 (Embodiment 2-2)

A neural network compensator 11 of the embodiment (Embodiment 2-2) in FIG. 19 also uses a current peak value iₚ, a d-axis inductance L_{d} (hat), a q-axis inductance L_{q} (hat), and an interlinkage magnetic flux φ (hat) as input signals, and uses a squared error (τ^{∗}-τ)² of present torque τ with respect to a torque command value τ^{∗} as the teacher signal. Meanwhile, a current peak command value iₚ^{∗} and a current phase command value θ₁^{∗} are output as output signals. Then, the output signals are derived from the input signals in a learning manner such that the teacher signal is minimized.

In other words, in this case also, in order to derive the current peak command value iₚ^{∗} providing optimal efficiency and the current phase command value θ₁^{∗} providing optimal efficiency for torque control, the current peak value iₚ, the d-axis inductance L_{d} (hat), the q-axis inductance L_{q} (hat), and the interlinkage magnetic flux φ (hat) are used as input signals, and the squared error (τ^{∗}-τ)² of the present torque τ with respect to the torque command value τ^{∗} is used for the teacher signal to be minimized. The neural network compensator 11 of this embodiment is also a multilayer neural network compensator, and repeats learning based on forward propagation and backpropagation to derive the current peak command value iₚ^{∗} and the current phase command value θ₁^{∗} that are optimal for minimizing the teacher signal in real time.

### Neural Network Compensator 11 (Embodiment 2-3)

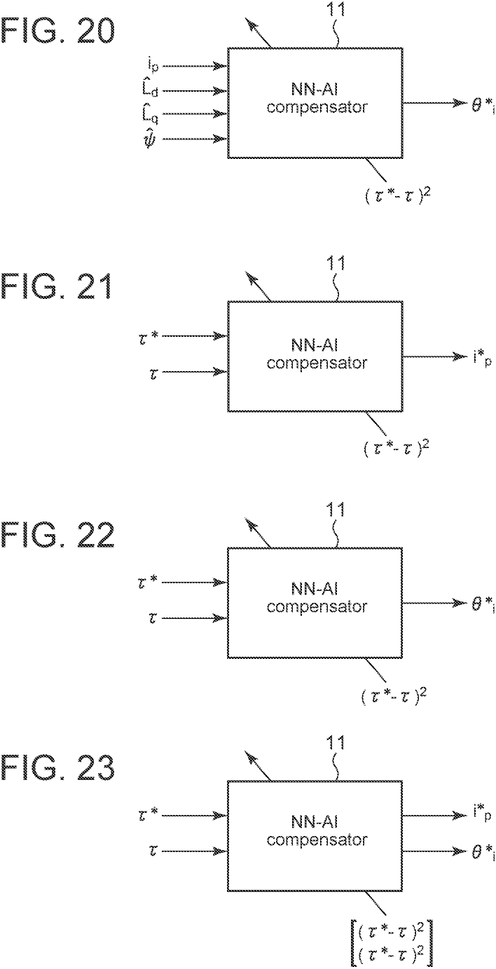

A neural network compensator 11 of the embodiment (Embodiment 2-3) in FIG. 20 also uses a current peak value iₚ, a d-axis inductance L_{d} (hat), a q-axis inductance L_{q} (hat), and an interlinkage magnetic flux φ (hat) as input signals, and uses a squared error (τ^{∗}-τ)² of present torque τ with respect to a torque command value τ^{∗} as a teacher signal. Meanwhile, a current phase command value θ₁^{∗} is output as an output signal. Then, the output signal is derived from the input signals in a learning manner such that the teacher signal is minimized.

In other words, in this case also, in order to derive the current phase command value θ₁^{∗} providing optimal efficiency, the current peak value iₚ, the d-axis inductance L_{d} (hat), the q-axis inductance L_{q} (hat), and the interlinkage magnetic flux φ (hat) are used as input signals, and the squared error (τ^{∗}-τ)² of the present torque τ with respect to the torque command value τ^{∗} is used as the teacher signal to be minimized. The neural network compensator 11 of this embodiment is also a multilayer neural network compensator, and repeats learning based on forward propagation and backpropagation to derive the current phase command value θ₁^{∗} that is optimal for minimizing the teacher signal in real time.

### Embodiment 3

Referring now to FIG. 21 to FIG. 23, a neural network compensator 11 of yet another embodiment will be described. As with the neural network compensator 11 in FIG. 1 and FIG. 4, an output signal of the neural network compensator 11 of this embodiment becomes an input to one end of a converter 13 and constitutes a part of a motor control device 1.

### Neural Network Compensator 11 (Embodiment 3-1)

A neural network compensator 11 of an embodiment (Embodiment 3-1) in FIG. 21 uses a torque command value τ^{∗} and present torque τ as input signals, and uses a squared error (τ^{∗}-τ)² of the present torque τ with respect to the torque command value τ^{∗} as a teacher signal. Then, with a current peak command value iₚ^{∗} being an output signal, the output signal is derived from the input signals in a learning manner such that the teacher signal is minimized.

In other words, in this case, in order to derive the current peak command value iₚ^{∗} that provides optimal efficiency for torque control, the torque command value τ^{∗} and the present torque τ are used as the input signals, and the squared error (τ^{∗}-τ)² of the present torque τ with respect to the torque command value τ^{∗} is used as the teacher signal to be minimized. The neural network compensator 11 of this embodiment is also a multilayer neural network compensator, and repeats learning based on forward propagation and backpropagation to derive the current peak command value iₚ^{∗} that is optimal for minimizing the teacher signal in real time.

### Neural Network Compensator 11 (Embodiment 3-2)

A neural network compensator 11 of an embodiment (Embodiment 3-2) in FIG. 22 also uses a torque command value τ^{∗} and present torque τ as input signals, and uses a squared error (τ^{∗}-τ)² of the present torque τ with respect to the torque command value τ^{∗} as a teacher signal. Meanwhile, as an output signal, a current phase command value θ₁^{∗} is output. Then, the output signal is derived from the input signals in a learning manner such that the teacher signal is minimized.

In other words, in this case also, in order to derive the current phase command value θ₁^{∗} that provides optimal efficiency, the torque command value τ^{∗} and the present torque τ are used as the input signals, and the squared error (τ^{∗}-τ)² of the present torque τ with respect to the torque command value τ^{∗} is used as the teacher signal to be minimized. The neural network compensator 11 of this embodiment is also a multilayer neural network compensator, and repeats learning based on forward propagation and backpropagation to derive the current phase command value θ₁^{∗} that is optimal for minimizing the teacher signal in real time.

### Neural Network Compensator 11 (Embodiment 3-3)

A neural network compensator 11 of an embodiment (Embodiment 3-3) in FIG. 23 also uses a torque command value τ^{∗} and present torque τ as input signals, and uses a squared error (τ^{∗}-τ)² of the present torque τ with respect to the torque command value τ^{∗} as a teacher signal. Meanwhile, as output signals, a current peak command value iₚ^{∗} and a current phase command value θ₁^{∗} are output. Then, the output signals are derived from the input signals in a learning manner such that the teacher signal is minimized.

In other words, in this case also, in order to derive the current peak command value iₚ^{∗} that provides optimal efficiency and the current phase command value θ₁^{∗} that provides optimal efficiency for torque control, the torque command value τ^{∗} and the present torque τ are used as the input signals, and the squared error (τ^{∗}-τ)² of the present torque τ with respect to the torque command value τ^{∗} is used as the teacher signal to be minimized. The neural network compensator 11 of this embodiment is also a multilayer neural network compensator, and repeats learning based on forward propagation and backpropagation to derive the current peak command value iₚ^{∗} and the current phase command value θ₁^{∗} that are optimal for minimizing the teacher signal in real time.

The present invention described above in detail makes it possible to achieve highly efficient control in controlling the motor 6 (permanent-magnet synchronous motor) by deriving, in a learning manner, the current peak value command iₚ^{∗} or the current phase command value θ₁^{∗}, or both thereof, which minimize the squared error between the torque command τ^{∗} and the present torque τ, or the squared error between the current command values (iₚ^{∗}, i_{q}^{∗}) and the present current (iₚ, i_{q}) on the basis of the neural network, and then by performing control using the derived command values.

In other words, according to the present invention, the neural network learning uses the squared torque error (τ^{∗}-τ) or the squared q-axis current error (i_{q}^{∗}-i_{q}) or the squared current peak value error (iₚ^{∗}-iₚ) as the teacher signal, uses the present torque τ, the q-axis current i_{q}, the current peak value iₚ and the command values τ^{∗}, i_{q}^{∗} and iₚ^{∗} thereof and further the motor parameter (plant parameter) d-axis inductance L_{d}, the q-axis inductance L_{q}, the interlinkage magnetic flux φ as the input signals to the neural network learning, and uses the current phase command value θ₁^{∗} and the current peak command value iₚ^{∗} as the outputs by the neural network learning.

Thus, neural network outputs that optimize (minimize) teacher signals can be derived in a learning manner at the time of real-time feedback control. The optimization learning is derived in a learning manner (automatically) even when target values are changed or disturbance torque is changed, consequently providing the effect of highly efficient control. In addition, even when parameters (motor parameters: d-axis inductance L_{d}, q-axis inductance L_{q}, and interlinkage magnetic flux φ) of a control object (the motor 6) change, optimal learning can be performed without identifying (or estimating) the values thereof, so that high efficiency can be achieved.

The input signals of the neural network compensator 11 shown in each of the above-described embodiments are not limited thereto, but may be other combinations of, or all of the q-axis current command value i_{q}^{∗}, the q-axis current i_{q}, the current peak command value iₚ^{∗}, the current peak value iₚ, the d-axis inductance L_{d}, the q-axis inductance L_{q}, the magnetic flux density φ, the torque command value τ^{∗}, and the present torque τ.

Further, the control objects of the motor control device of the present invention are not limited to the permanent-magnet synchronous motors shown in the embodiments except for the invention of claim 10.

### DESCRIPTION OF REFERENCE NUMERALS

1 motor control device
3 motor control unit
6 motor
11 neural network compensator
12 speed controller
13 converter
14 current controller

1. A motor control device that is a control device for controlling a motor, comprising:
a neural network compensator receiving an input signal and repeating learning based on forward propagation and backpropagation thereby to derive an output signal providing optimal efficiency,
wherein the input signal is any one of, or a combination of, or all of a motor current, a motor parameter, and torque,
the output signal is a current command value and/or a current phase command value, and
the motor is controlled on the basis of the output signal derived by the neural network compensator.

2. The motor control device according to claim 1,
wherein the input signal is any one of, or a combination of, or all of a q-axis current command value i_{q}*, a q-axis current i_{q}, a current peak command value iₚ*, a current peak value ip, a d-axis inductance L_{d}, a q-axis inductance L_{q}, a magnetic flux density φ, a torque command value τ*, and present torque τ.

3. The motor control device according to claim 1, wherein the output signal is a current peak command value iₚ* and/or a current phase command value θᵢ*.

4. The motor control device according to any one of claims 1, wherein the neural network compensator uses a squared torque error or a squared current error as a teacher signal, and derives the output signal from the input signal in a learning manner such that the teacher signal is minimized.

5. The motor control device according to claim 4, wherein the teacher signal is any one of a squared error (τ*-τ)² of present torque τ with respect to a torque command value τ*, a squared error (iₚ*-iₚ)² of a current peak value iₚ with respect to a current peak command value iₚ*, and a squared error (i_{q}*-i_{q})² of a q-axis current i_{q} with respect to a q-axis current command value i_{q}*.

6. The motor control device according to claim 1, wherein the neural network compensator uses a current peak command value iₚ* and a current peak value iₚ as the input signals, uses a squared error (iₚ*-iₚ)² of the current peak value iₚ with respect to the current peak command value iₚ* as a teacher signal, and uses a current phase command value θᵢ* as the output signal so as to derive the output signal from the input signals in a learning manner such that the teacher signal is minimized.

7. The motor control device according to claim 1, wherein the neural network compensator uses a q-axis current command value i_{q}* and a q-axis current i_{q} as the input signals, uses a squared error (i_{q}*-i_{q})² of the q-axis current iq with respect to the q-axis current command value i_{q}* as a teacher signal, and uses a current phase command value θᵢ* as the output signal so as to derive the output signal from the input signals in a learning manner such that the teacher signal is minimized.

8. The motor control device according to claim 1, wherein the neural network compensator uses a current peak value iₚ, a d-axis inductance L_{d}, a q-axis inductance L_{q}, and a magnetic flux density φ as the input signals, uses a squared error (τ*-τ)² of present torque τ with respect to a torque command value τ* as a teacher signal, and uses a current peak command value iₚ* and/or a current phase command value θᵢ* as the output signal so as to derive the output signal from the input signals in a learning manner such that the teacher signal is minimized.

9. The motor control device according to claim 1, wherein the neural network compensator uses a torque command value τ* and present torque τ as the input signals, uses a squared error (τ*-τ)² of the present torque τ with respect to the torque command value τ* as a teacher signal, and uses a current peak command value iₚ* and/or a current phase command value θᵢ* as the output signal so as to derive the output signal from the input signals in a learning manner such that the teacher signal is minimized.

10. The motor control device according to any one of claims 1, wherein the motor is a permanent-magnet synchronous motor.

11. The motor control device according to any one of claims 1, including:
a motor drive unit driving and controlling the motor; and
a motor control unit controlling the motor by the motor drive unit on the basis of the output signal of the neural network compensator.
